(19) United States
(12) Patent Application Publication
(10) Pub. No.: US 2004/0263892 A1
(43) Pub. Date: Dec. 30, 2004

(54) Information processisng apparatus, information processing method, and control program

(75) Inventor: Tatsuro Uchida, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/874,164

(22) Filed: Jun. 24, 2004

(30) Foreign Application Priority Data
Jun. 27, 2003 (JP) 2003-183646

(51) Int. Cl. G06F 15/00; G06K 9/36

(52) U.S. Cl. 358/1.13; 382/276

(57) ABSTRACT

A data processing apparatus for executing a data process by a first operating system in the case where a second operating system of same architecture type whose functions are expanded larger than those of the first operating system exists is constructed by: a first converting unit for converting predetermined draw information which is issued by a print instructing application into a first print command in a first drawing format through a graphic interface according to the architecture of the first operating system; a first forming unit for converting the first print command converted by the first converting unit into first intermediate data according to the architecture of the first operating system; a second converting unit for modifying the first intermediate data converted by the first forming unit and converting it into second intermediate data whose output architecture is expanded larger than those of the first operating system; and a second forming unit for forming a second print command according to the output architecture of the second operating system on the basis of the second intermediate data converted by the second converting unit.

### BACKGROUND OF THE INVENTION

1. Field of the Invention

The invention relates to a data processing apparatus for executing a data process a print data forming method, a storing medium in which a computer-readable program has been stored, and the program.

2. Related Background Art

Hitherto, in such a kind of printer control system, generally, an operating system for controlling processes of an application or the like has been installed on a host computer side.

Functions of such an operating system continue to progress along with changes in architecture.

Therefore, in the case of using operating systems of different architecture, for example, when a printer driver module which has been operating in one operating system is reused by another operating system, the reuse is limited to a portion in which those two different operating systems can share internal processes. Thus, only some codes can be reused, or the like.

Specifically speaking, when drawing architecture is changed from an environment of 16 bits to that of 32 bits, with respect to a device driver which operates in the 16-bit environment (architecture), only a part of resources can be shared in the 32-bit environment. Thus, a new device driver which conforms with the 32-bit architecture needs to be developed each time.

This is mainly because architecture of an interface of a printer driver which is managed by the operating system is specified according to the operating system and the printer drivers which operate on the different operating systems need to have different interfaces.

### SUMMARY OF THE INVENTION

However, in correspondence to the diversification of platforms of various information processing apparatuses including data processing apparatuses such as personal computers and the like, the operating systems which make such platforms operative are also increasingly continuing to be diversified.

In such an environment of data processing systems, on a device development manufacturer side, a load of the continuous provision of, for example, the printer drivers as device drivers for a printer for each operating system is heavy, and the distribution of development resources of the printer drivers cannot be helped. Therefore, there is a strong demand for resolution of such problems.

As mentioned above, there is such a problem that in association with the progress of the operating system called fundamental software, in correspondence to the architecture of the operating system, an immense modification of architecture of a device driver module on the data processing apparatus side is necessary, so that the manufacturer is burdened with the development, or the like.

The invention is made to solve at least one of the above problems and according to one aspect of the invention, there is provided a data processing apparatus for executing a data process by a first operating system in the case where a second operating system of same architecture type whose functions are expanded larger than those of the first operating system exists, wherein: predetermined draw information which is issued by a print instructing application is converted into a first print command in a first drawing format through a graphic interface according to the architecture of the first operating system; the converted first print command is converted into first intermediate data according to the architecture of the first operating system; further, the converted first intermediate data is modified and converted into second intermediate data whose output architecture is expanded larger than those of the first operating system; and a second print command according to the output architecture of the second operating system is formed on the basis of the converted second intermediate data. Therefore, by making the most of resources of the second operating system, a printer driver for the first operating system having the higher functions can be provided. It is also possible to provide such a data processing apparatus, a print data forming method, a storing medium in which a computer-readable program has been stored, and the program, wherein an excellent development environment which can remarkably reduce a development load of the printer driver for the first operating system can be constructed.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram showing an example of a printer control system showing the first embodiment of the invention;

FIG. 2 is a block diagram for explaining a construction of modules on a host computer side of the printer control system shown in FIG. 1;

FIG. 3 is a block diagram for explaining a construction of modules on the host computer side of the printer control system shown in FIG. 1;

FIG. 4 is a flowchart showing an example of a first data processing procedure in the printer control system according to the invention;

FIG. 5 is a flowchart showing an example of a second data processing procedure in the printer control system according to the invention;

FIG. 6 is a block diagram showing an example of a printer filter in a printer control system showing the second embodiment of the invention; and

FIG. 7 is a diagram for explaining a memory map in a storing medium for storing various data processing programs which can be read out by a data processing apparatus according to the invention.

### DETAILED DESCRIPTION OF THE PREFERRED EMBODIMENTS

Preferred embodiments of the invention will now be described hereinbelow with reference to the drawings.

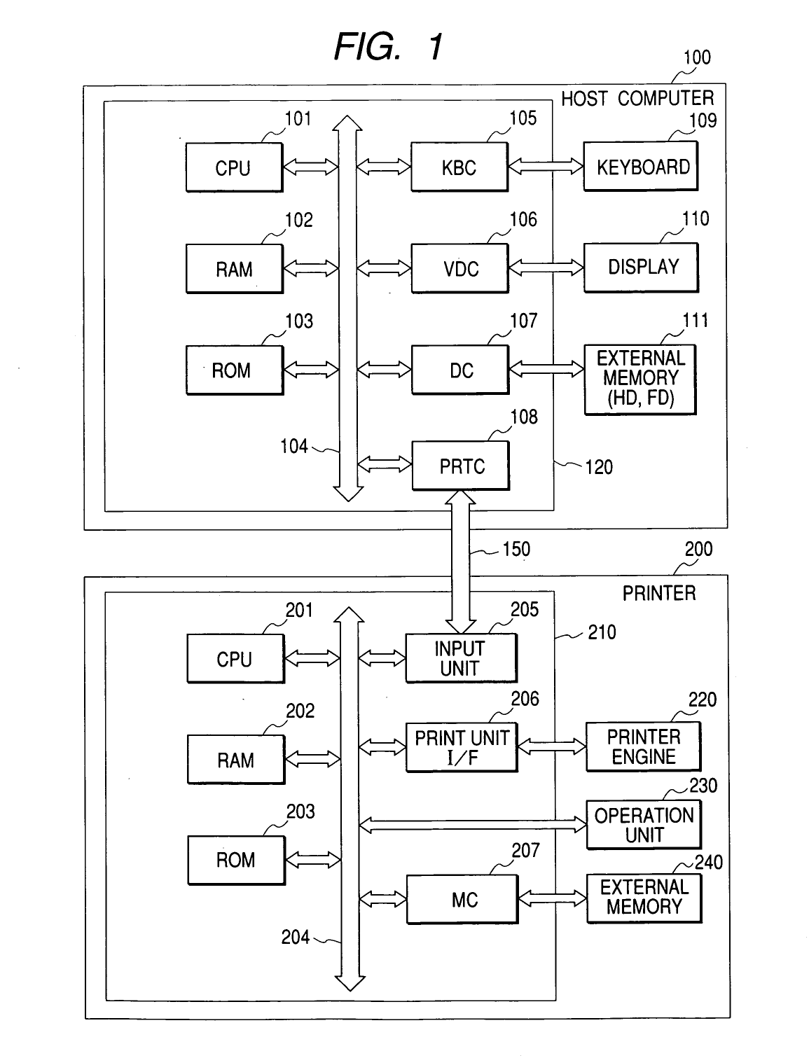

FIG. 1 is a block diagram showing an example of a printer control system showing the first embodiment of the invention. The printer control system corresponds to a construction in which a host computer 100 and a printer 200 can communicate through a bidirectional interface (I/F) 150. Naturally, the invention can be applied to any of a single apparatus, a system comprising a plurality of apparatuses, and a system which is connected through a network such as LAN (Local Area Network), WAN (Wide Area Network), or the like and executes processes so long as the functions of the invention are executed.

As actual product forms to which the invention can be applied, an FD (Flexible Disk), CD-ROM (Compact Disc ROM), an Internet Web site, and BBS (Bulletin Board System: a message exchanging system using a computer) can be mentioned.

That is, a program of the invention is supplied from the FD or CD-ROM to the printer control system and the printer control system can be connected to the Internet or BBS.

In FIG. 1, the host computer 100 comprises: a CPU 101; a RAM 102; a ROM 103; a keyboard controller (KBC) 105; a video controller (VDC) 106; a disk controller (DC) 107; a printer controller (PRTC) 108; a keyboard 109; a display 110; and an external memory The printer 200 comprises: a CPU 201; a RAM 202; a ROM 203; an input unit 205; a print unit interface (I/F) 206; a memory controller (MC) 207; a printer engine 220; an operation unit 230; an external memory 240; and the like.

First, a construction of each section of the host computer 100 will be described in detail. The CPU 101 is a central processing unit for integratedly controlling each device connected to a system bus 104. On the basis of a document processing program or the like stored in a program area in the ROM 103 or the external memory 111, the CPU 101 executes processes of a document in which a figure, an image, characters, a table (including a spreadsheet or the like), and the like exist mixedly.

The CPU 101 executes, for example, a developing (rasterizing) process of an outline font into a display information RAM set in the RAM 102 and enables “WYSIWYG” (What You See Is What You Get: function which can print an image in the same size and form as those seen on a CRT display screen) on the display 110.

Further, the CPU 101 opens various registered windows on the basis of commands instructed by a mouse cursor (not shown) or the like on the display 110 and executes various data processes.

When the user executes printing by using the printer 200, he opens the window regarding setting of the printing onto the display 110 and can execute setting of a print processing method to the printer driver including setting of the printer 200 and selection of a print mode.

The RAM 102 functions as a main memory, a work area, or the like of the CPU 101. The ROM 103 is divided into a font area, a program area, and a data area. Font data and the like which are used upon execution of the document processes has been stored in the font area on the ROM 103 or the external memory 111.

A BIOS (Basic Input Output System), an operating system (hereinafter, referred to as OS), or the like as a control program of the CPU 101 has been stored in the program area on the ROM 103 or the external memory 111.

Further, various data which is used when the document processes or the like are executed has been stored in the data area on the ROM 103 or the external memory 111.

The keyboard controller (KBC) 105 controls a key input from the keyboard 109 or a pointing device (not shown). The video controller (VDC) 106 controls display of the display 110.

The disk controller (DC) 107 controls an access to the external memory 111.

The printer controller (PRTC) 108 is connected to the printer 200 through the bidirectional I/F 150 and executes a control process of communication with the printer 200. The keyboard 109 has various keys. The display 110 displays a figure, an image, characters, a table, or the like on the basis of a draw command from the OS.

The external memory 111 is constructed by a hard disk (HD), a flexible disk (FD), or the like and used as an area for storing a boot program, the OS, various applications, font data, a user file, an edit file, a printer control command forming program (hereinafter, referred to as a printer driver), and the like.

The foregoing CPU 101, RAM 102, ROM 103, keyboard controller (KBC) 105, video controller (VDC) 106, disk controller (DC) 107, and printer controller (PRTC) 108 are arranged on a computer control unit 120.

A construction of each section of the printer 200 will now be described in detail. The CPU 201 functions as a central processing unit for integratedly controlling each device connected to a system bus 204. On the basis of a control program or the like stored in a program area in the ROM 203 or a control program or the like stored in the external memory 240, the CPU 201 outputs an image signal as output information to the printer engine 220.

The CPU 201 can execute a communicating process with the host computer 100 through the input unit 205 and can notify the host computer 100 of various information (including a status and the like) or the like in the printer 200.

The RAM 202 functions as a main memory, a work area, or the like of the CPU 201 and is constructed so that a memory capacity can be expanded by an option RAM (not shown) which is connected to an expansion port.

The RAM 202 is used as an output information developing area, an environmental data storing area, an NVRAM, or the like. The ROM 203 is divided into a font area, a program area, and a data area.

Font data and the like which are used when the output information is formed are stored in the font area on the ROM 203. A control program and the like of the CPU 201 are stored in the program area on the ROM 203.

Further, when the external memory 240 such as a hard disk or the like is not connected to the printer 200, information and the like which are used on the host computer 100 are stored in the data area on the ROM 203.

The input unit 205 executes transmission and reception of data between the printer 200 and the host computer 100 through the bidirectional I/F 150.

The print unit I/F 206 executes transmission and reception of data between the CPU 201 and the printer engine 220. The memory controller (MC) 207 controls an access to the external memory 240.

The printer engine 220 executes the printing operation on the basis of the control of the CPU 201. Although not shown, the printer engine 220 is constructed by: a conveying mechanism of a recording medium; a semiconductor laser unit; a photosensitive drum; a developing unit; a fixing unit; a drum cleaning unit; a separating unit; and the like. The printer engine 220 executes printing by a well-known electrophotographic process.

The operation unit 230 comprises: switches for various operations; display means (for example, an LED display); and the like. The external memory 240 is constructed by a hard disk (HD), an IC card, or the like and connected as an option to the printer 200.

The external memory 240 stores font data, an emulation program, form data, and the like. An access to the external memory 240 is controlled by the memory controller (MC) 207.

The external memory 240 is not limited to one memory but a plurality of external memories can be provided. That is, the apparatus can be constructed in such a manner that in addition to built-in fonts, a plurality of memories such as option cards and external memories in which programs for interpreting printer control languages of different language systems have been stored can be connected to the printer 200.

Further, the apparatus can be constructed in such a manner that it has the NVRAM (not shown) and stores printer mode setting information from the operation unit 230.

The foregoing CPU 201, RAM 202, ROM 203, input unit 205, print unit I/F 206, and memory controller (MC) 207 are arranged on a printer control unit 210.

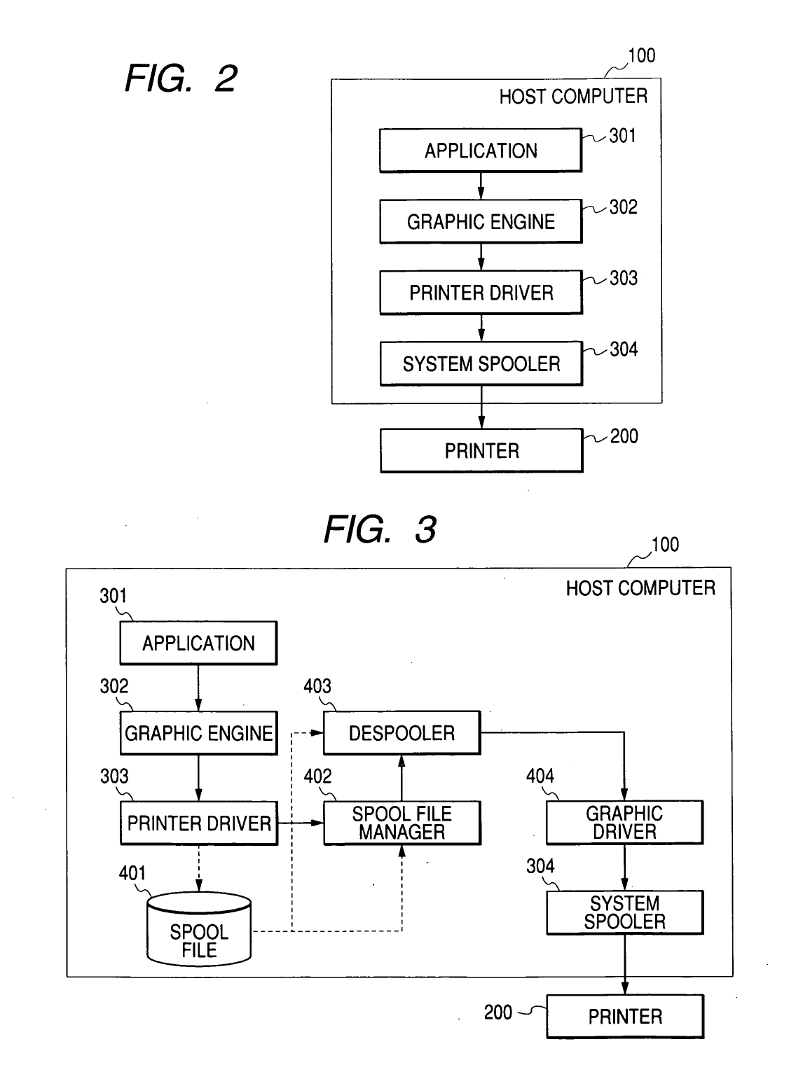

FIGS. 2 and 3 are block diagrams for explaining a construction of modules on the host computer 100 side of the printer control system shown in FIG. 1. FIGS. 2 and 3 correspond to an example of a module construction of typical printing processes in the host computer 100 to which a printing apparatus such as a printer or the like is connected directly or through a network.

In FIG. 2, an application 301, a graphic engine 302, a printer driver 303, and a system spooler 304 are program modules which exist as files stored in the external memory 111 shown in FIG. 1 mentioned above. When those program modules are executed, they are loaded into the RAM 102 by the OS or a module using the modules and executed.

The application 301 and the printer driver 303 can be added to the HD of the external memory 111 through the FD or CD-ROM (not shown) of the external memory 111 or the network (not shown).

The application 301 stored in the external memory 111 is loaded into the RAM 102 and executed. However, when the application 301 allows the printer 200 to execute the printing, print data is outputted (drawn) by using the graphic engine 302 which has similarly been loaded in the RAM 102 and can be executed.

The graphic engine 302 similarly loads the printer driver 303 prepared every printing apparatus into the RAM 102 from the external memory 111 and sets the output of the application 301 into the printer driver 303.

Further, the graphic engine 302 converts a GDI (Graphic Device Interface) function which is received from the application 301 into a DDI (Device Driver Interface) function and outputs the DDI function to the printer driver 303.

On the basis of the DDI function received from the graphic engine 302, the printer driver 303 converts it into a control command which can be recognized by the printer, for example, a PDL (Page Description Language).

The converted printer control command is transmitted through the system spooler 304 loaded in the RAM 102 by the OS and is outputted as print data to the printer 200 via the bidirectional I/F 150.

In addition to the print system comprising the host computer 100 and the printer 200 shown in FIGS. 1 and 2, the printer control system according to the embodiment further has such a construction that the print data from the application is temporarily converted into intermediate code data by the printer driver 303 and spooled as shown in FIG. 3.

Therefore, in the example of the printer control system shown in FIG. 2, the application 301 is released from the printing process at a point of time when the printer driver 303 finishes the process for converting all print commands from the graphic engine 302 into control commands of the printer 200.

On the other hand, in the example of the printer control system shown in FIG. 3, the application 301 is released from the printing process at a point of time when the printer driver 303 converts all print commands into the intermediate code data and outputs them to a spool file 401. Ordinarily, those processes can be finished for a short time in the latter example.

In the printer control system shown in FIG. 3, the contents in the spool file 401 can be modified.

Thus, to the print data from the application, functions which are not provided for the application, that is, functions such as magnification/reduction, N-up printing for reducing a plurality of pages and printing them onto one page, and the like can be realized.

For those purposes, the system of FIG. 2 can be expanded so as to spool the print commands by the intermediate code data as shown in FIG. 3.

To modify the print data, generally, setting is performed from the window that is provided by the printer driver 303 and the printer driver 303 stores contents of the setting into the RAM 102 or the external memory 111.

The example of the printer control system shown in FIG. 3 will now be described in detail hereinbelow.

As shown in FIG. 3, in this example of the expanded print data processing system, the printer driver 303 receives the print command from the graphic engine 302 by the foregoing DDI.

The printer driver 303 converts the received print command into the intermediate code and outputs it to the spool file 401. The printer driver 303 also stores modification setting regarding the set print data and the like into the spool file 401.

Although the spool file 401 is formed as a file onto the external memory 111, it can be formed on the RAM 102.

Further, the printer driver 303 loads a spool file manager 402 stored in the external memory 111 into the RAM 102 and notifies the spool file manager 402 of a situation of creation of the spool file 401.

After that, the spool file manager 402 discriminates whether or not a graphic driver 404 can form the print data in accordance with the contents of the modification setting regarding the print data stored in the spool file 401.

The spool file 401 manages the intermediate data on a unit basis of a logic page as a page outputted from the application 301.

The spool file 401 manages the modification setting set into the printer driver 303 by the user as mentioned above, for example, the setting of the N-up printing mode (a plurality of logic pages are reduced and arranged so that they can be arranged onto one physical page) or the like.

For example, in the case of a 2-up printing mode, when the creation of the spool file 401 for two logic pages is completed, the spool file manager 402 determines that the graphic driver 404 can form the print data.

When the spool file manager 402 determines that the print data can be formed by the graphic driver 404, the spool file manager 402 loads a despooler 403 stored in the external memory 111 into the RAM 102 and instructs the despooler 403 to execute a printing process of the intermediate data described in the spool file 401.

The despooler 403 loads the graphic driver 404 stored in the external memory 111 into the RAM 102 simultaneously with the initialization. The despooler 403 modifies the intermediate data included in the spool file 401 in accordance with contents of environment information which is instructed by the spool file manager 402, further converts the modified intermediate data into data in a format which can be interpreted by the graphic driver 404, and outputs it to the graphic driver 404.

The format which can be interpreted by the graphic driver 404 is not the DDI which is specified by the operating system by which the printer control system of the invention operates but a DDI which is specified by another operating system. A base portion of the graphic driver 404 is formed by presuming such another operating system.

The graphic driver 404 forms the print data comprising the printer control command on the basis of the received DDI and outputs it to the printer 200 through the system spooler 304.

General processes in the printer control system according to the embodiment of the invention in the system constructed as mentioned above will now be described.

In this system, there is shown an example in which on the operating system such as “Windows (registered trademark) 95/98/98 Second Edition/Millennium Edition” of Microsoft Corporation in which the 16-bit graphic engine has been implemented, or the like, the graphic driver 404 for another operating system in which the 32-bit graphic engine has been implemented, for example, “Windows (registered trademark) 2000/Xp” of Microsoft Corporation is used. However, the scope where the invention can be applied is not limited to the example of the operating systems mentioned above but, naturally, the invention can be applied to a device driver of an operating system which is improving along with a future progress of the operating system based on the use of the resources of the device drivers corresponding to the existing operating systems. As will be also explained hereinafter, the operating system is not limited to the series of “Windows (registered trademark)”.

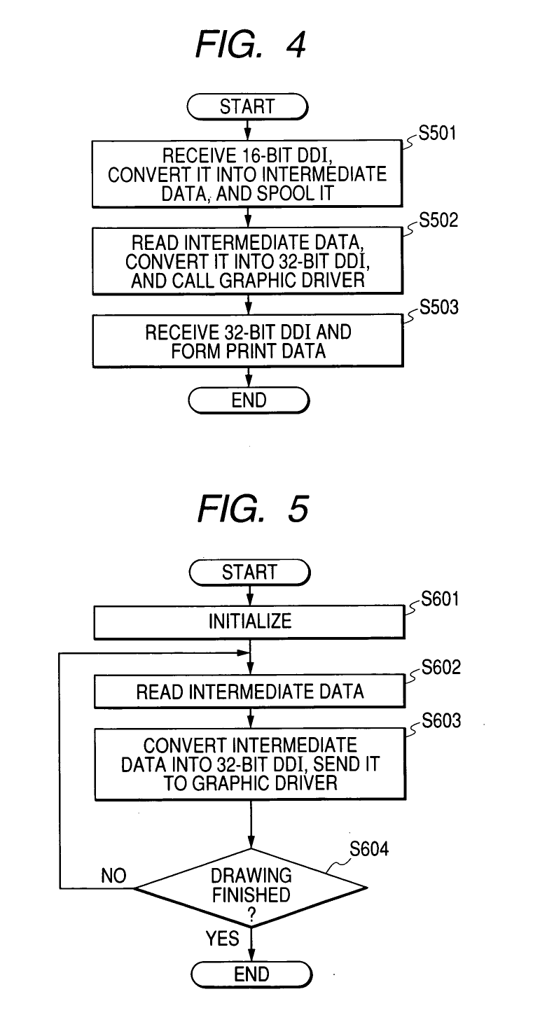

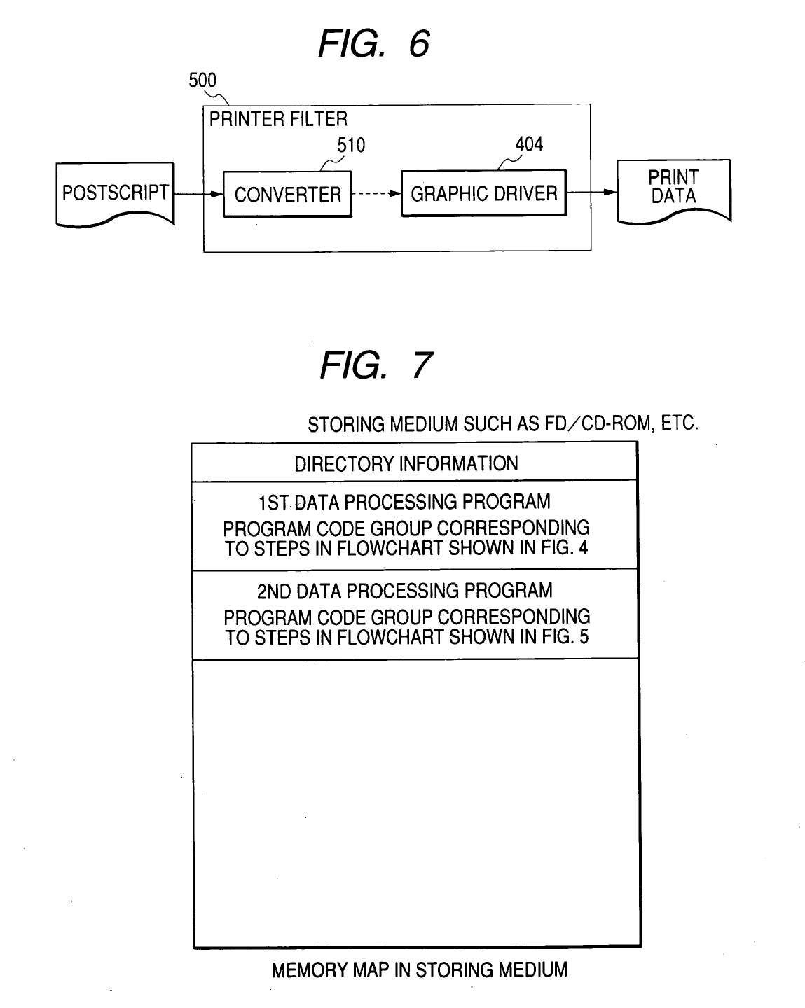

FIG. 4 is a flowchart showing an example of a first data processing procedure in the printer control system according to the invention and corresponds to a data conversion processing procedure by each module of the host computer 100 shown in FIG. 3. S501 to S503 show processing steps. The control program stored in the external memory 111 shown in FIG. 1 is loaded into the RAM 102 and the CPU 101 executes those steps. The data converting process of the invention is executed in the following order.

First, in the data converting process in the embodiment, the printer driver 303 is called by, for example, the 16-bit DDI and converted into a unique intermediate data format and spooled as a spool file 401 (S501).

The despooler 403 reads out the intermediate information of the 16-bit construction and calls the graphic driver 404 corresponding to 32 bits while converting the intermediate information into, for example, a 32-bit DDI in a form also in consideration of modification information (S502).

Subsequently, the graphic driver 404 converts the received 32-bit DDI into print data comprising control commands of a target printer (in the embodiment, the printer 200) (forms such print data), sends it to the printer 200 through the system spooler 304, and finishes the process.

On the printer 200 side, the print data comprising the control commands of the target printer obtained by converting the 32-bit DDI which is transmitted from the system spooler 304 is converted into a video signal of a bit map by using the well-known printing method. After that, the video signal is printed as image data onto a print medium.

The data process in the despooler 403 shown in FIG. 3 will now be described further in detail.

FIG. 5 is a flowchart showing an example of a second data processing procedure in the printer control system according to the invention and corresponds to the data processing procedure by the despooler 403 shown in FIG. 3. S601 to S604 show processing steps. The control program stored in the external memory 111 shown in FIG. 1 is loaded into the RAM 102 and the CPU 101 executes those steps. For simplicity of explanation, explanation will be made on the assumption that the modification setting is not particularly set.

First, when the spool file manager 402 determines that drawing preparation for one page has been completed, the despooler 403 is loaded into a memory (for example, the RAM 102).

Upon initialization, the despooler 403 executes an initializing process of the graphic driver 404 in addition to the initialization of various operation parameters and the operation for reading out the print setting information or the like from the spool file 401 (S601).

After that, the despooler 403 reads out the draw information (intermediate code) of, for example, the 16-bit construction recorded in the form of the intermediate code into the spool file 401 by the printer driver 303 (S602).

The despooler 403 converts the read-out intermediate code into data in the format of the 32-bit DDI which can be processed by the graphic driver 404 at the post stage. The despooler 403 further executes an inquiring process about the information from the graphic driver 404.

After completion of all preparation, the graphic driver 404 is called by a function interface which is specified by the 32-bit DDI (S603).

The processes in steps S602 and S603 are repetitively executed until it is determined that the page printing has been finished with respect to the processed intermediate code (S604). If it is determined that the printing has been finished (drawing has been finished), all processes by the despooler 403 are finished.

There is a case where the graphic driver 404 inquires of the despooler 403 about the information as necessary.

An interface for such an information inquiry is also specified by the 32-bit DDI. It is necessary for the despooler 403 to hold each draw data therein in order to respond to the information inquiry from the graphic driver 404.

A specific example of the graphic driver 404 shown in FIG. 3 will be described hereinbelow.

The graphic driver 404 in the embodiment is a printer driver which takes charge of a graphic portion in “Windows (registered trademark) 2000/Xp”. The despooler 403 uses this driver as it is.

The most important role of the graphic driver 404 is to form the print data to the target printer from the 32-bit DDI.

However, since the graphic driver 404 has been created on the assumption that it operates on “Windows (registered trademark) 2000/Xp”, there is a possibility that it cannot properly operate in such a state due to a difference in architecture of the operating systems.

In this case, to apply the invention, means for absorbing the difference is architecture of the operating systems is necessary.

For example, if it cannot properly operate due to a difference of a library function group which is used, a library which absorbs such a difference is separately prepared and means for enabling the graphic driver 404 to directly or indirectly use such a library, or the like is prepared.

Naturally, if the graphic driver 404 side also has a portion which excessively depends on the original operating system “Windows (registered trademark) 2000/Xp”, it is desirable to change it to a code which does not depend on the operating system.

By applying the invention, ability and functions which cannot inherently be realized by the operating system on which the system operates can be also provided.

For example, in the graphic engine 302 of the operating system “Windows (registered trademark) 95/98/98 Second Edition/Millennium Edition” of Microsoft Corporation in which the 16-bit graphic engine has been implemented and which has been described in the embodiment, since an entry of 16 bits is presented to the printer driver 303, the printer driver 303 can support only up to a space which can be expressed by 16 bits.

This means that according to the above operating system, the printing cannot be performed by a combination of a large sheet size and high resolution exceeding the 16-bit space.

According to the embodiment, however, since the graphic driver 404 is installed from another operating system, the above limitation can be loosened. Such an example will be described hereinbelow.

The graphic driver 404 shown in the embodiment is a driver developed for “Windows (registered trademark) 2000/Xp” of Microsoft Corporation in which the 32-bit graphic engine has been implemented and a coordinate space which can be handled is a 32-bit space.

Although the graphic engine 302 of the operating system to which the invention is applied corresponds to 16 bits, each operating system of “Windows (registered trademark) 95/98/98 Second Edition/Millennium Edition” of Microsoft Corporation is an operating system corresponding to the processing operation of 32 bits.

By allowing the despooler 403 to execute the process by 32 bits by using the above construction, the despooler 403 is enabled to easily handle the 32-bit space. Coordinate values of 16 bits received by the printer driver 303 through the spool file 401 can be magnified in the range of 32 bits by the despooler 403 and sent to the graphic driver 404, so that the printing process in the 32-bit space can be realized.

The above point will be described with respect to another example. For example, the printer driver 303 presents such low resolution that a width and length of a sheet lie within a range which does not exceed 16 bits to the graphic engine 302, receives the print data in this range, and stores it into the spool file 401.

The despooler 403 reads out the spool file 401, properly magnifies the coordinate values or the like described in the spool file 401 so as to obtain output resolution which is inherently required by the user, and transfers them to the graphic driver 404.

Naturally, the graphic driver 404 is initialized by the despoiler 403 at the resolution designated by the user.

By applying the invention as mentioned above, there is such an effect that the printing process of the combination of the large sheet size and high resolution which exceed inherently the limitation of the operating system can be executed.

(Second Embodiment)

In the above first embodiment, there is shown an example in which on the operating system such as “Windows (registered trademark) 95/98/98 Second Edition/Millennium Edition” of Microsoft Corporation or the like having the 16-bit graphic engine, the invention is applied by using the printer driver which takes charge of the graphic portion for “Windows (registered trademark) 2000/Xp” of Microsoft Corporation in which the 32-bit graphic engine has similarly been implemented as a graphic driver 404.

The second embodiment will now be described hereinbelow with respect to an example in which the printer driver which takes charge of the graphic portion for “Windows (registered trademark) 2000/Xp” is used as a graphic driver 404 on the OS of “Linux” (product name).

Generally, a PDL (Page Description Language) called “PostScript” (registered trademark) of Adobe Systems Inc. in U.S.A. is used as a standard printing format in “Linux”.

For a printer which cannot output the print data by “PostScript” (registered trademark), the print data is converted into data in a format as an output target from “PostScript” (registered trademark) by using a printer filter.

A “PostScript” (registered trademark) file is inputted to such a printer filter. The print data is converted into the print data comprising a control command of the target printer by the printer filter.

FIG. 6 is a block diagram showing an example of the printer filter in the printer control system showing the second embodiment of the invention and corresponds to an outline of the operation of the printer filter.

In FIG. 6, a printer filter 500 is a printer filter of “Linux”. In this filter, a converter 510 to form a 32-bit DDI from “PostScript” (registered trademark) and the graphic driver 404 which takes charge of the graphic portion for “Windows (registered trademark) 2000/Xp” as mentioned above are contained.

The converter 510 reads out the “PostScript” (registered trademark) file, converts it into the data of the 32-bit DDI format, and prepares for corresponding to the information inquiry from the graphic driver 404.

Immediately after such a preparation is finished, the converter 510 calls the graphic driver 404 by the 32-bit DDI.

The graphic driver 404 converts the 32-bit DDI into the print data comprising the control command of the target printer and forms a file.

In a manner similar to the foregoing embodiment, the graphic driver 404 needs to be changed in order to correspond to “Linux” as an execution environment of the embodiment.

According to the embodiment, as described above, by applying the invention, the printer driver which operates in another operating system can be easily made operative as a part of the printer driver in the target operating system.

In other words, this means that by making the most of the printer driver in the operating system serving as a base, such an effect that the development load of the printer driver for the other operating systems can be reduced is obtained.

A construction of a data processing program which can be read out by the data processing apparatus according to the invention will now be described hereinbelow with reference to a memory map shown in FIG. 7.

FIG. 7 is a diagram for explaining the memory map in a storing medium for storing various data processing programs which can be read out by the data processing apparatus according to the invention.

Although not shown, information to manage a program group which is stored into the storing medium, for example, version information, implementors, and the like are also stored and, there is also a case where information which depends on the OS or the like on the program reading side, for example, icons for identifying and displaying the programs, and the like are also stored.

Further, data which depends on various programs is also managed in the above directory. There is also a case where a program to install the various programs into a computer and, if the installing program has been compressed, a program for decompressing it, and the like are also stored.

The functions shown in FIGS. 4 and 5 in the embodiments can be executed by the host computer in accordance with a program which is installed from the outside. In such a case, the invention is also applied to a case where an information group including the programs is supplied to an output apparatus from a storing medium such as CD-ROM, flash memory, FD, or the like or from an external storing medium through a network.

As mentioned above, naturally, one of the features of the invention are also accomplished by a method whereby a storing medium in which program codes of software for realizing the functions of the embodiments mentioned above have been recorded is supplied to a system or an apparatus and a computer (or a CPU or an MPU) of the system or the apparatus reads but and executes the program codes stored in the storing medium.

In this case, the program codes themselves read out from the storing medium realize the novel functions of the invention and the storing medium in which the program codes have been stored constructs the invention.

Therefore, a format of the program is not limited but any format such as object code, program which is executed by an interpreter, script data which is supplied to the OS, or the like can be used so long as it has the functions of the program.

As a storing medium for supplying the program, for example, it is possible to use a flexible disk, a hard disk, an optical disk, a magnetooptic disk, an MO, a CD-ROM, a CD-R, a CD-RW, a magnetic tape, a non-volatile memory card, a ROM, a DVD, or the like.

In this case, the program codes themselves read out from the storing medium realize the functions of the embodiments and the storing medium in which the program codes have been stored constructs the invention.

As another supplying method of the program, it can be realized by a method whereby the apparatus is connected to a homepage of Internet by using a browser of the client computer and the computer programs themselves of the invention or the compressed file including an automatic installing function is downloaded into a recording medium such as a hard disk or the like. The program supplying method can be also realized by a method whereby the program codes constructing the program of the invention is divided into a plurality of files and the respective files are downloaded from different homepages. That is, a WWW server, an ftp server, and the like for downloading the program files for realizing the function processes of the invention by a computer to a plurality of users are also incorporated in Claims of the invention.

The program supplying method can be also realized by a method whereby the program of the invention is encrypted and stored into the storing medium such as a CD-ROM or the like and distributed to the users, the user who can satisfy predetermined conditions is allowed to download key information for decrypting the encryption from the homepage through the Internet, and the encrypted program is executed by using the key information and installed into the computer.

Naturally, the invention incorporates not only a case where a computer executes the read-out program codes, so that the functions of the embodiments mentioned above are realized but also a case where the OS (Operating System) or the like which operates on the computer executes a part or all of actual processes on the basis of instructions of the program codes and the functions of the embodiments mentioned above are realized by those processes.

Further, naturally, the invention also incorporates a case where the program codes read out from the storing medium are written into a memory provided for a function expanding board inserted into a computer or a function expanding unit connected to a computer, thereafter, a CPU or the like provided for the function expanding board or the function expanding unit executes a part or all of actual processes on the basis of instructions of the program codes, and the functions of the embodiments mentioned above are realized by those processes.

The invention is not limited to the foregoing embodiments but various modifications (including an organic combination of the embodiments) are possible on the basis of the spirit of the invention and they are not excluded from the scope of the invention.

Although various examples and embodiments of the invention have been shown and described above, it will be obviously understood by those with ordinary skill in the art that the spirit and scope of the invention are not limited to the specific explanation in the present specification but the following embodiments are also incorporated. Those embodiments will now be described hereinbelow.

There is disclosed the data processing apparatus for executing a data process by a first operating system in the case where a second operating system of same architecture type whose functions are expanded larger than those of the first operating system exists, comprising: first converting means (for example, the graphic engine 302 shown in FIG. 3) for converting predetermined draw information which is issued by a print instructing application into a first print command in a first drawing format through a graphic interface according to the architecture of the first operating system; first forming means (for example, the printer driver 303 shown in FIG. 3) for converting the first print command converted by the first converting means into first intermediate data according to the architecture of the first operating system; second converting means (for example, the despooler 403 and the spool file manager 402 shown in FIG. 3) for modifying the first intermediate data converted by the first forming means and converting it into second intermediate data whose output architecture is expanded larger than those of the first operating system; and second forming means (for example, the graphic driver 404 shown in FIG. 3) for forming a second print command according to the output architecture of the second operating system on the basis of the second intermediate data converted by the second converting means.

There is disclosed the print data forming method in the data processing apparatus for executing a data process by a first operating system in the case where a second operating system of same architecture type whose functions are expanded larger than those of the first operating system exists, comprising: a first converting step (step S501 shown in FIG. 4) of converting predetermined draw information which is issued by a print instructing application into a first print command in a first drawing format through a graphic interface according to the architecture of the first operating system; a first forming step (step S501 shown in FIG. 4) of converting the first print command converted in the first converting step into first intermediate data according to the architecture of the first operating system; a second converting step (step S603 shown in FIG. 5) of modifying the first intermediate data converted in the first forming step and converting it into second intermediate data whose output architecture is expanded larger than those of the first operating system; and a second forming step (step S503 shown in FIG. 4) of forming a second print command according to the output architecture of the second operating system on the basis of the second intermediate data converted in the second converting step.

As described above, according to the invention, in the data processing apparatus for executing a data process by a first operating system in the case where a second operating system of same architecture type whose functions are expanded larger than those of the first operating system exists: predetermined draw information which is issued by a print instructing application is converted into a first print command in a first drawing format through a graphic interface according to the architecture of the first operating system; the converted first print command is converted into first intermediate data according to the architecture of the first operating system; further, the converted first intermediate data is modified and converted into second intermediate data whose output architecture is expanded larger than those of the first operating system; and a second print command according to the output architecture of the second operating system is formed on the basis of the converted second intermediate data. Therefore, the following effects are obtained. That is, by making the most of the resources of the second operating system, the printer driver for the first operating system having the higher functions can be provided, an excellent development environment which can remarkably reduce the development load of the printer driver for the first operating system can be constructed, and the like.

What is claimed is:

1. A data processing apparatus for executing a data process by a first operating system in the case where a second operating system of same architecture type whose functions are expanded larger than those of said first operating system exists, comprising:
first converting means for converting predetermined draw information which is issued by a print instructing application into a first print command in a first drawing format through a graphic interface according to the architecture of said first operating system;
first forming means for converting said first print command converted by said first converting means into first intermediate data according to the architecture of said first operating system;
second converting means for modifying said first intermediate data converted by said first forming means and converting it into second intermediate data whose output architecture is expanded larger than those of said first operating system; and
second forming means for forming a second print command according to the output architecture of said second operating system on the basis of the second intermediate data converted by said second converting means.

2. An apparatus according to claim 1, wherein resolution of said second intermediate data is higher than resolution which is specified by said first intermediate data.

3. An apparatus according to claim 1, wherein a drawing space which is specified by said second intermediate data is wider than a drawing space which is specified by said first intermediate data.

4. An apparatus according to claim 1, wherein said second converting means forms the second intermediate data according to the output architecture of said second operating system corresponding to said second forming means on the basis of the first intermediate data formed by said first forming means.

5. An apparatus according to claim 1, wherein said second converting means can provide information to be responded in accordance with the output architecture of said second operating system in accordance with a request from said second forming means.

6. A print data forming method in a data processing apparatus for executing a data process by a first operating system in the case where a second operating system of same architecture type whose functions are expanded larger than those of said first operating system exists, comprising:
a first converting step of converting predetermined draw information which is issued by a print instructing application into a first print command in a first drawing format through a graphic interface according to the architecture of said first operating system;
a first forming step of converting said first print command converted by said first converting step into first intermediate data according to the architecture of said first operating system;
a second converting step of modifying said first intermediate data converted by said first forming step and converting it into second intermediate data whose output architecture is expanded larger than those of said first operating system; and
a second forming step of forming a second print command according to the output architecture of said second operating system on the basis of the second intermediate data converted by said second converting step.

7. A method according to claim 6, wherein resolution of said second intermediate data is higher than resolution which is specified by said first intermediate data.

8. A method according to claim 6, wherein a drawing space which is specified by said second intermediate data is wider than a drawing space which is specified by said first intermediate data.

9. A method according to claim 6, wherein in said second converting step, the second intermediate data according to the output architecture of said second operating system corresponding to said second forming step is formed on the basis of the first intermediate data formed by said first forming step.

10. A method according to claim 6, wherein in said second converting step, information to be responded can be provided in accordance with the output architecture of said second operating system in accordance with a request from said second forming step.

11. A control program for allowing a computer to execute a print data forming method in a data processing apparatus for executing a data process by a first operating system in the case where a second operating system of same architecture type whose functions are expanded larger than those of said first operating system exists, wherein said method comprises:
a first converting step of converting predetermined draw information which is issued by a print instructing application into a first print command in a first drawing format through a graphic interface according to the architecture of said first operating system;
a first forming step of converting said first print command converted by said first converting step into first intermediate data according to the architecture of said first operating system;
a second converting step of modifying said first intermediate data converted by said first forming step and converting it into second intermediate data whose output architecture is expanded larger than those of said first operating system; and
a second forming step of forming a second print command according to the output architecture of said second operating system on the basis of the second intermediate data converted by said second converting step.

12. A data processing apparatus for executing a data process by a first operating system in the case where a second operating system of same architecture type whose functions are expanded larger than those of said first operating system exists, comprising:
a first converter, adapted for converting predetermined draw information which is issued by a print instructing application into a first print command in a first drawing format through a graphic interface according to the architecture of said first operating system;
a first forming unit, adapted for converting said first print command converted by said first converter into first intermediate data according to the architecture of said first operating system;
a second converter, adapted for modifying said first intermediate data converted by said first forming unit and converting it into second intermediate data whose output architecture is expanded larger than those of said first operating system; and
a second forming unit, adapted for forming a second print command according to the output architecture of said second operating system on the basis of the second intermediate data converted by said second converter.
